(19) United States
(12) Patent Application Publication
(10) Pub. No.: US 2026/0252363 A1
(43) Pub. Date: Aug. 27, 2026

(54) METHOD FOR APPLICATION TYPE DETECTION

(71) Applicant: MEDIATEK INC., Hsinchu City (TW)

(72) Inventors: Chu-Chi Chiu, Hsinchu City (TW); Shih-Hsuan Lai, Hsinchu City (TW); Chih-Yang Yin, Hsinchu City (TW); Wei-Ling Yu, Hsinchu City (TW)

(73) Assignee: MEDIATEK INC., Hsinchu City (TW)

(21) Appl. No.: 19/062,029

(22) Filed: Feb. 25, 2025

(51) Int. Cl. G06F 9/445; G06N 3/0464

(52) U.S. Cl. CPC G06F 9/44505; G06N 3/0464

(57) ABSTRACT

A method for application (APP) type detection includes: collecting multiple system level information of multiple APPs, wherein the multiple APPs are related to at least two APP types; and utilizing a contrastive learning method to train a machine learning model for obtaining a trained model, wherein the trained model is utilized for detecting an APP type of each of the multiple APPs, and the multiple system level information are utilized as multiple input data of the machine learning model.

### BACKGROUND

The present disclosure is related to application (APP) type detection, and more particularly, to a method for APP type detection with aid of contrastive learning method.

For an electronic device (e.g. a cellphone or a tablet), APP type detection has gradually become an important issue. The system policy (e.g. the system policy related to a central processing unit (CPU) or a graphics processing unit (GPU) in the electronic device) can be adjusted according to the detected APP type to achieve a balance between the power consumption and the performance. For a conventional method, the APP will be identified/classified by establishing a whitelist, and more particularly, the system policy will be adjusted according to the comparison between a package name of the APP and the whitelist. However, since the package name of the APP is easily tampered with, some problems may occur. As a result, a method and an associated device that can effectively perform the APP type detection are urgently needed.

### SUMMARY

It is therefore one of the objectives of the present disclosure to provide a method for APP type detection and an associated non-transitory machine-readable medium for storing a program code that provides the method when executed, to address the above-mentioned issues.

According to an embodiment of the present disclosure, a method for APP type detection is provided. The method may comprise: collecting multiple system level information of multiple APPs, wherein the multiple APPs are related to at least two APP types; and utilizing a contrastive learning method to train a machine learning model for obtaining a trained model, wherein the trained model is utilized for detecting an APP type of each of the multiple APPs, and the multiple system level information are utilized as multiple input data of the machine learning model.

Each of the multiple system level information comprises one of a system call, an application programming interface (API) call, and information related to a performance monitoring unit (PMU).

The machine learning model is based on a temporal convolution network (TCN) architecture.

In an embodiment, the multiple APPs comprise at least one first APP belonging to a first APP type and at least one second APP belonging to a second APP type different from the first APP type, and each of positive pairs in a feature space comprises two features corresponding to a same APP type, wherein the two features are generated by the machine learning model respectively, and a similarity of the positive pairs in the feature space is maximized through the contrastive learning method.

Each of negative pairs in the feature space comprises a first feature corresponding to the first APP type and a second feature corresponding to the second APP type, the first feature and the second feature are generated by the machine learning model respectively, and a similarity of the negative pairs in the feature space is minimized through the contrastive learning method.

In an embodiment, the multiple APPs comprise at least one first APP belonging to a first APP type and at least one second APP belonging to a second APP type different from the first APP type, the multiple input data comprise multiple first input data corresponding to the first APP type and at least one second input data corresponding to the second APP type. The step of utilizing the contrastive learning method to train the machine learning model comprises: performing an augmentation operation upon a first input data corresponding to the first APP type, to generate an augmented result; and training the machine learning model according to a loss function, wherein the loss function is related to multiple features, and the multiple features are generated by the machine learning model according to the multiple first input data, the augmented result and the at least one second input data, respectively.

The step of performing the augmentation operation upon the first input data corresponding to the first APP type, to generate the augmented result comprises: in response to the first input data being a system call sequence, randomly masking a section of the system call sequence to generate the augmented result; or in response to the first input data being a system call count, randomly masking a discontinuous system call to generate the augmented result.

The step of training the machine learning model according to the loss function comprises: encoding the multiple first input data, respectively, to generate multiple first features through the machine learning model; encoding the augmented result to generate a third feature through the machine learning model; and encoding the at least one second input data, to generate at least one second feature through the machine learning model.

The method further comprises: utilizing the trained model to perform a detection operation upon a foreground APP, to generate a detection result; and determining a corresponding system policy according to the detection result, wherein different APP types correspond to different system policies.

The method further comprises: after obtaining the trained model, training the trained model through a multilayer perceptron.

According to an embodiment of the present disclosure, a non-transitory machine-readable medium for storing a program code is provided, wherein when loaded and executed by a processor, the program code instructs the processor to perform a method for APP type detection, and the method may comprise: collecting multiple system level information of multiple APPs, wherein the multiple APPs are related to at least two APP types; and utilizing a contrastive learning method to train a machine learning model for obtaining a trained model, wherein the trained model is utilized for detecting an APP type of each of the multiple APPs, and the multiple system level information are utilized as multiple input data of the machine learning model.

One of the benefits of the present disclosure is that, by the method of the present disclosure, the model trained by the contrastive learning method can be more robust to different versions of the same APP, and the accuracy of APP type detection can be improved. In addition, the system policy can be adjusted according to the detection result, so that a balance between the power consumption and the performance of the hardware circuit in the electronic device can be achieved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present disclosure.

FIG. 2 is a flow chart of a method for adjusting a system policy with aid of APP type detection according to an embodiment of the present disclosure.

FIG. 3 is a diagram illustrating multiple feature spaces obtained by a supervised learning method and a contrastive learning method, respectively, according to an embodiment of the present disclosure.

FIG. 4 is a diagram illustrating some implementation details of model training performed by a contrastive learning method according to an embodiment of the present disclosure.

FIG. 5 is a diagram illustrating some implementation details of adjusting a system policy with aid of APP type detection according to an embodiment of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

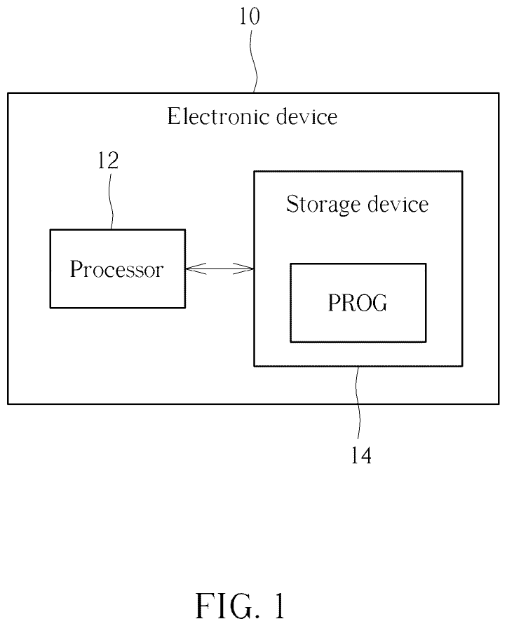

FIG. 1 is a diagram illustrating an electronic device 10 according to an embodiment of the present disclosure. By way of example, but not limitation, the electronic device 10 may be a portable device such as a smartphone, a computer, or a tablet. The electronic device 10 may include a processor 12 and a storage device 14. For example, the processor 12 may include at least one of a central processing unit (CPU), a graphics processing unit (GPU), and/or a performance monitoring unit (PMU), and the processor 12 may be a single-core processor or a multi-core processor, but the present disclosure is not limited thereto. For example, the storage device 14 is a non-transitory machine-readable medium, and it is arranged to store computer program code PROG. The processor 12 is equipped with software execution capability. The computer program code PROG may include a machine learning-based algorithm. When loaded and executed by the processor 12, the computer program code PROG instructs the processor 12 to perform a method for application (APP) type detection and/or determining/adjusting a system policy related to the processor 12 with aid of application (APP) type detection as proposed by the present disclosure. The electronic device 10 may be regarded as a computer system using a computer program product that includes a computer-readable medium containing the computer program code PROG. That is, the method of the present disclosure may be embodied on the electronic device 10.

In one embodiment, the electronic device 10 may be configured to perform operations of the training phase. In this embodiment, the computer program code may include an untrained (original) machine learning model, and the processor 12 in the electronic device 10 trains the machine learning model using a contrastive learning method according to the present disclosure to obtain a trained model for detecting an APP type. Alternatively, the electronic device 10 may be further configured to also perform operations of the inference phase. For example, the processor 12 of the electronic device 10 may detect the corresponding APP type upon system level information of a foreground app dynamically obtained during operation based on the trained model, to perform corresponding operations according to the corresponding APP type. In another embodiment, the electronic device 10 may be configured to perform operations of the inference phase. In this embodiment, the computer program code may include a trained model for detecting an APP type (for example, the trained model is loaded/downloaded from other electronic device), so that the electronic device 10 can detect the corresponding APP type upon system level information of a foreground app dynamically obtained during operation based on the trained model, to perform corresponding operations according to the corresponding APP type. For example, determining the system policy (i.e., resource configuration, such as operating frequency, power voltage, etc.) that matches/corresponds to the detected APP type, so that if the current system policy is different from the determined system policy, adjustments are made according to the determined system policy, such as adjusting the operating frequency of the processor 12, thereby operating based on the system policy/resource configuration that matches the detected APP type, but the present disclosure is not limited to this. For convenience of explanation, the training phase and inference phase are described together below, but as mentioned above, the present disclosure is not limited to this example description.

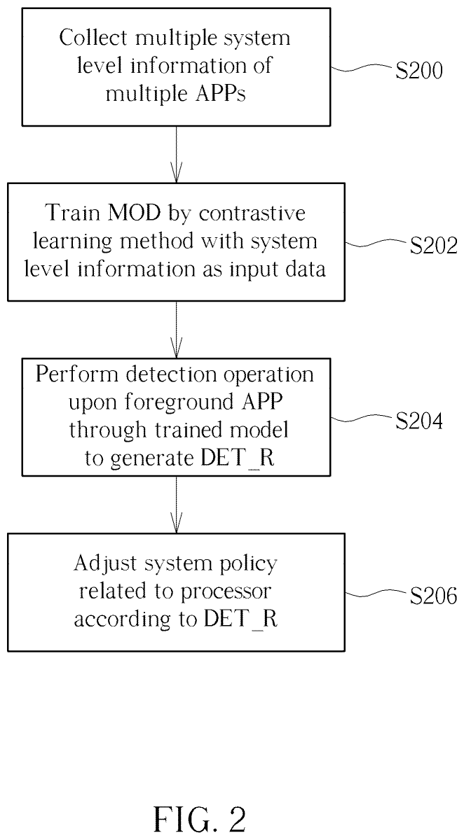

FIG. 2 is a flow chart of a method for adjusting a system policy with aid of APP type detection according to an embodiment of the present disclosure. As shown in FIG. 2, the method may include Steps S200-S206.

In Step S200, multiple system level information of multiple APPs may be collected. In one example, multiple APPs may run on the processor 12, and the multiple system level information of the APPs are collected in advance, for example, the device that performs the training phase and the inference phase can also be performed on one same device. Alternatively, multiple system level information of the APPs may be collected by receiving from other electronic device, for example, the device that performs the training phase and the device that performs the inference phase are different devices. In the embodiment, each of the multiple system level information may include one of a system call, an application programming interface (API) calls, and information related to the PMU, but the present disclosure is not limited thereto. Take the system call as an example. The representation of the system call may be a system call sequence or a system call count, wherein the system call sequence indicates the whole system call order, and the system call count indicates the number of system calls at a fixed time interval. For different versions of the same APP, the collected system call sequence/count will be similar, so that the collected system call sequence/count can be utilized as a feature of a model to be trained. In the embodiments, multiple given APPs may be classified into multiple (at least two) APP types in advance, that is, for the multiple given APPs, each APP relates to a corresponding APP type. It is noted that, for multiple APPs classified into the same APP type, the collected system call sequence/count related to the multiple APPs will also be similar. In the embodiment, at least two APP types may be preset according to the actual operation requirements of each application, wherein different APP types may correspond to different system policies. For example, these APP types can include a first APP type corresponding to high system demands and a second APP type corresponding to low system demands. However, the present disclosure is not limited to this.

In Step S202, a model MOD (e.g., a machine learning model) may be trained by a machine learning method with the system level information as input data, and more particularly, may be trained by a contrastive learning method. In this embodiment, the model MOD may be based on a temporal convolution network (TCN) architecture. Regarding the TCN, the dilated causal convolution can enable the model MOD to have a larger receptive field, and the residual connection can solve the vanishing gradient problem. Since the TCN is well known to those skilled in the art, further descriptions are omitted here for brevity.

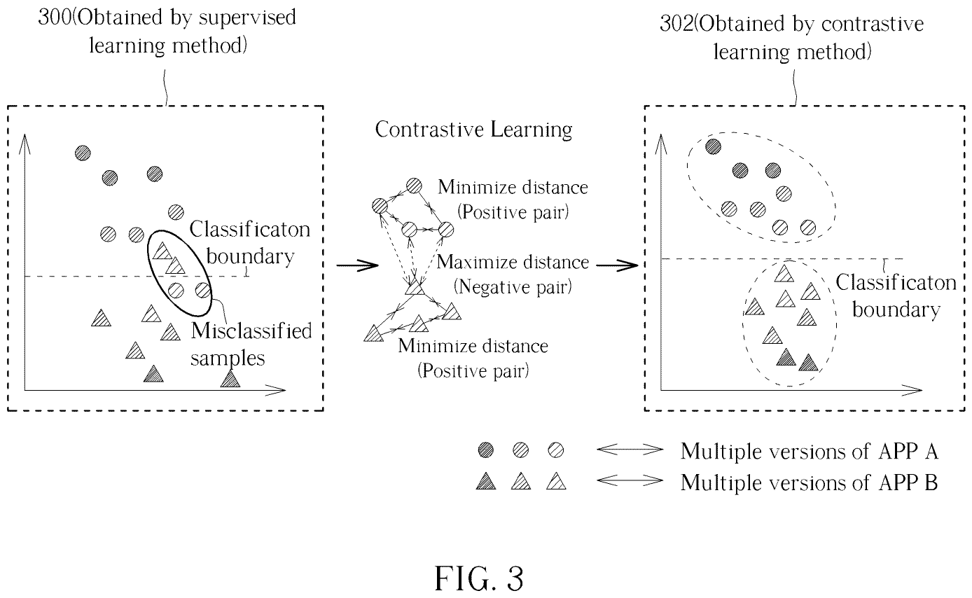

Specifically, please refer to FIG. 3. FIG. 3 is a diagram illustrating multiple feature spaces 300 and 302 obtained by a supervised learning method and a contrastive learning method, respectively, according to an embodiment of the present disclosure. Assume that the APPs may include multiple versions of an APP A and multiple versions of an APP B, wherein the APP B is different from the APP A, and the multiple versions of the APP A and the multiple versions of an APP B belong/correspond to two APP types. Hence, two samples from different versions of the same APP (corresponding to one APP type) are positive samples of each other (also referred as a positive pair), two samples from different APP types (corresponding to different APP types) are negative samples of each other (also referred as a negative pair), all samples from the multiple versions of the APP A and the multiple versions of the APP B may be classified in the feature spaces 300 and 302 by the supervised learning method and the contrastive learning method, respectively. In the feature spaces 300 and 302, circles represent the multiple versions of the APP A, and triangles represent the multiple versions of the APP B. For example, the density of straight lines in each circle may represent three versions of the APP A, wherein the circle with the densest straight line represents the oldest version of the APP A, the circle with the sparsest straight line represents the latest version of the APP A, and a remaining circle represents a middle version of the APP A. Similarly, the density of straight lines in each triangle may represent three versions of the APP B, wherein the triangle with the densest straight line represents the oldest version of the APP B, the triangle with the sparsest straight line represents the latest version of the APP B, and a remaining triangle represents a middle version of the APP B.

As shown in FIG. 3, there may be some misclassified samples in the feature space 300 obtained by the supervised learning method, which may cause the accuracy of APP type detection to decrease. To address this issue, the present disclosure adopts the contrastive learning method to train the model MOD. In detail, a positive pair in the feature space may include two features corresponding to two samples of the multiple versions of the same APP, and a distance of the positive pair in the feature space is minimized (e.g., pulled closer) through the contrastive learning method (i.e., the similarity of positive pairs is maximized). In addition, a negative pair in the feature space may include a feature corresponding to one sample of the multiple versions of the APP A and another feature corresponding to one sample of the multiple versions of the APP B, and a distance of the negative pair in the feature space is maximized (e.g., pushed away) through the contrastive learning method (i.e., the similarity of negative pairs is minimized). In this way, the model MOD can be more robust to different versions of the same APP, and the accuracy of APP type detection can be improved.

In some embodiments, multiple APPs may be classified into preset multiple APP types in advance. For example, samples corresponding to APPs classified into the same APP type may be positive samples of each other, and one sample corresponding to any of APPs classified into an APP type and another sample corresponding to any of APPs classified into another APP type may be negative samples of each other. In detail, a positive pair in the feature space may include two features corresponding to the same APP type, and a distance of the positive pair in the feature space is minimized (e.g., pulled closer) through the contrastive learning method (i.e., the similarity of positive pairs is maximized). In addition, a negative pair in the feature space may include a feature corresponding to an APP type and another feature corresponding to another APP type, and a distance of the negative pair in the feature space is maximized (e.g., pushed away) through the contrastive learning method (i.e., the similarity of negative pairs is minimized). In this way, the model MOD can be more robust to APPs with different APP types, and the accuracy of APP type detection can be improved. For ease of explanation, the embodiments of the present disclosure use various versions of the APP A as a first APP type and various versions of the APP B as a second APP type for illustration in FIG. 3, but the present disclosure is not limited to this.

In some embodiments, after the model MOD is trained through the contrastive learning method, the model MOD may be further trained through an optional supervised learning algorithm (e.g. a multilayer perceptron (MLP)), so that the accuracy of APP type detection can be further improved. These alternative designs all fall within the scope of the present disclosure.

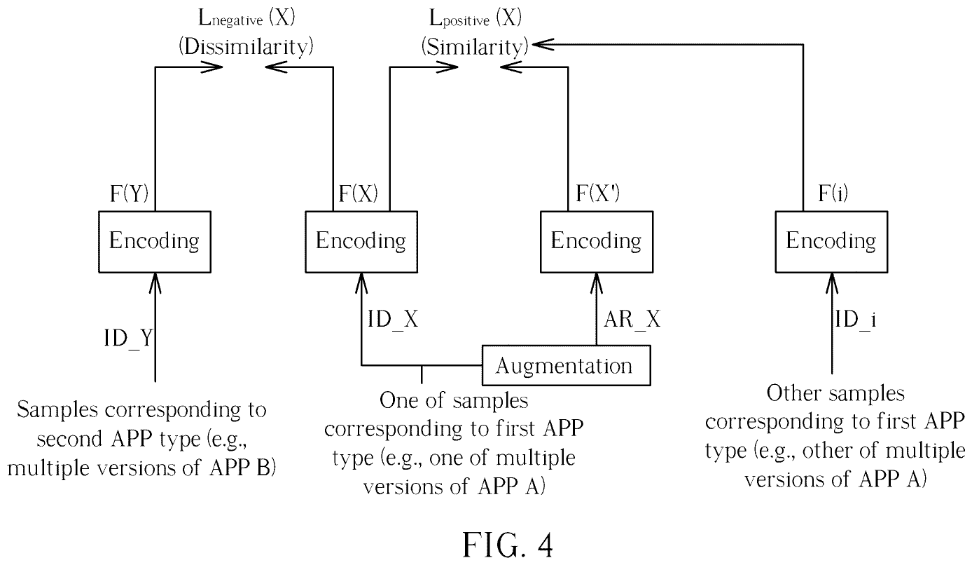

FIG. 4 is a diagram illustrating some implementation details of model training performed by a contrastive learning method according to an embodiment of the present disclosure. Typically, during the process of training a model, dividing the entire training dataset into multiple batches for training can improve training efficiency and stability. Understandably, a batch refers to a small portion of the training data used in a single iteration, and batch size B refers to the number of samples contained in each batch, wherein B is an integer greater than 1, such as 256. In the embodiment of the present disclosure, the training data correspond to associated application (APP) types. For simplification, an example with two APP types is provided. In this example, the first APP type uses various versions of the APP A as an example, and the second APP type uses various versions of the APP B as an example. However, the present disclosure is not limited to this. In this embodiment, different versions of the same APP may be in the same batch. For example, a batch BAT may include samples associated with the multiple versions of the APP A and at least one samples associated with the multiple versions of the APP B. The following example takes the calculation of the similarity of one sample (also referred as input data) ID_X and its augmented result AR_X corresponding to the first APP type as an example for explanation. As shown in FIG. 4, system level information corresponding to one of the multiple versions of the APP A in the batch BAT may act as input data ID_X, and an augmentation operation may be performed upon the input data ID_X to generate the augmented result AR_X, wherein the input data ID_X and augmented result AR_X derived from the input data ID_X should be regarded as a positive pair, and they correspond to the same APP type. Specifically, the augmentation operation may be performed according to the representation of the system level information. Take the system level information being the system call as an example. In response to the input data ID_X being the system call sequence, a section of the system call sequence may be randomly masked to generate the augmented result AR_X. In response to the input data ID_X being the system call count, a discontinuous system call may be randomly masked to generate the augmented result AR_X. In addition, other samples in the same batch that correspond to the first APP type may act as at least one input data ID_i, wherein the input data ID_i and ID_X relate to the same APP type. In the embodiment, the input data ID_X and each of the input data ID_i are also positive pair. In addition, all samples in the same batch that correspond to the second APP type may act as input data ID_Y, wherein the input data ID_X and ID_i relate to different APP types. In the embodiment, the input data ID_X and each of the input data ID_Y are negative pair. It should be noted that, for the sake of simplification, only one sample corresponding to the second APP type is shown in FIG. 4. However, the present disclosure is not limited to this. For example, the same batch can include multiple samples corresponding to the second APP type. In the example shown in FIG. 4, the sum of the total number of samples corresponding to the first APP type and the total number of samples corresponding to the second APP type is equal to the batch size, wherein the total number of input data ID_i is the total number of samples corresponding to the first APP type minus 1.

Afterwards, the input data ID_X may be encoded through the model MOD to generate a feature F(X), the augmented result AR_X may be encoded through the model MOD to generate a feature F(X′), each of the input data ID_Y may be encoded through the model MOD to generate a corresponding feature F(Y), and each of the input data ID_i may also be encoded through the model MOD respectively to generate a corresponding feature F(i), wherein F(X), F(X′) and F(i) correspond to the same APP type, F(X) and F(Y) correspond to the different APP types, and numbers i, X, Y may be an integer between 1 and B. The model MOD may be trained according to at least one loss function to minimize the value of the at least one loss function, for example, maximize the similarity of features corresponding to the same APP type in the batch BAT and minimize the similarity of features corresponding to the different APP types in the batch BAT. In an exemplary embodiment, for the input data ID_X, the loss function Lpositive (X) and Lnegative (X) may be expressed as follows:

$${L}_{positive} ( X ) = - [ Similarity ( F ( X ) , F ( {X}^{′} ) ) + {\sum }_{i = 1}^{B} Similarity ( F ( X ) , F ( i ) ) ] ,$$

$$i \neq X$$

wherein F(i) and F(X) correspond to the same APP type;

$${L}_{negative} ( X ) = {\sum }_{Y = 1}^{B} Similarity ( F ( X ) , F ( Y ) ) ,$$

$$Y \neq X$$

wherein F(Y) and F(X) correspond to the different APP types;

Further, in an exemplary embodiment, the loss function may be expressed as follows:

$${L}_{s u m} = {\sum }_{X = 1}^{B} [ {L}_{p o s i t i v e} ( X ) + {L}_{negative} ( X ) ]$$

wherein the function Similarity( ) is arranged to calculate the similarity between two features. In one embodiment, Cosine Similarity may be used to measure the similarity between two features, and it evaluates the similarity of two features by calculating the cosine value between them. The value of cosine similarity is between −1 and 1, where 1 means the two features are exactly the same (with the highest similarity), −1 means the two features are completely opposite (with the lowest similarity). In some embodiments, the augmentation operation may also be performed upon the input data ID_i in order to generate multiple augmentation results, and the multiple augmentation results may be encoded through the model MOD to generate multiple features F(i′) for calculating the similarity.

In some embodiments, for a case where multiple APPs are classified into multiple APP types in advance (e.g., samples corresponding to APPs classified into the same APP type may be positive samples of each other, and any sample corresponding to APPs classified into an APP type and any sample corresponding to APPs classified into another APP type may be negative samples of each other). Under this case, samples corresponding to the APPs classified into the same APP type may be in the same batch. For example, the batch BAT may include samples corresponding to multiple APPs classified into the same APP type for acting as multiple positive samples. system level information of a positive sample corresponding to a first APP type in the batch BAT may act as the input data ID_X, and an augmentation operation may be performed upon the input data ID_X to generate the augmented result AR_X. In addition, remaining of the multiple system level information of positive samples corresponding to the first APP type in the batch BAT may act as multiple input data ID_i, wherein the number of input data ID_i may be the total number of samples corresponding to the first APP type minus 1. The input data ID_X may be encoded through the model MOD to generate a feature F(X), the augmented result AR_X may be encoded through the model MOD to generate a feature F(X′), and each of the multiple input data ID_i may be encoded through the model MOD respectively to generate multiple features F(i). The model MOD may be trained according to the above-mentioned loss function to maximize the similarity of features corresponding to the same APP type (such as the first APP type) in the batch BAT and minimize the similarity of features corresponding to the different APP types in the batch BAT. Since details of the loss function can be known by referring to the above paragraphs, similar descriptions are not repeated here for brevity.

In another aspect, Since the features F(X) and F(Y) correspond to different APP types, they constitute a negative pair. Therefore, the similarity calculated from the features F(X) and F(Y) should be minimized to reflect dissimilarity, as shown in FIG. 4. That is, the distance of a negative pair (e.g. the features F(X) and F(Y)) is pushed away through the contrastive learning method, as shown in FIG. 3. In another embodiment, the similarity of negative pairs can be used as the denominator of the loss function, and the similarity of positive pairs can be used as the numerator of the loss function. Thus, the model MOD can also be trained by minimizing the value of the loss function through the contrastive learning method. Since the operations related to similarity between two features are well known to those skilled in the art, further descriptions are omitted here for brevity.

Please refer back to FIG. 2. After the model MOD has been trained through the contrastive learning method, a trained model for detecting an APP type can be obtained. Step S204 may be entered.

In Step S204, a detection operation may be performed upon a foreground APP by utilizing the trained model, to generate a detection result DET_R. For example, according to the detection result DET_R, the foreground APP can be classified into one of the preset APP types, such as a high system demand APP or a low system demand APP. For example, the high system demand APP may be an APP associated with gaming or benchmark, and the low system demand APP may be an APP associated with clock or social media. For example, under a condition that a system demand of an APP is higher than a predetermined criterion, the APP may be preset to the high system demand APP. Under a condition that a system demand of an APP is lower than the predetermined criterion, the APP may be preset to the low system demand APP. In some embodiments, for any foreground APP, the trained model may determine which APP type the foreground APP is according to the detection result DET_R.

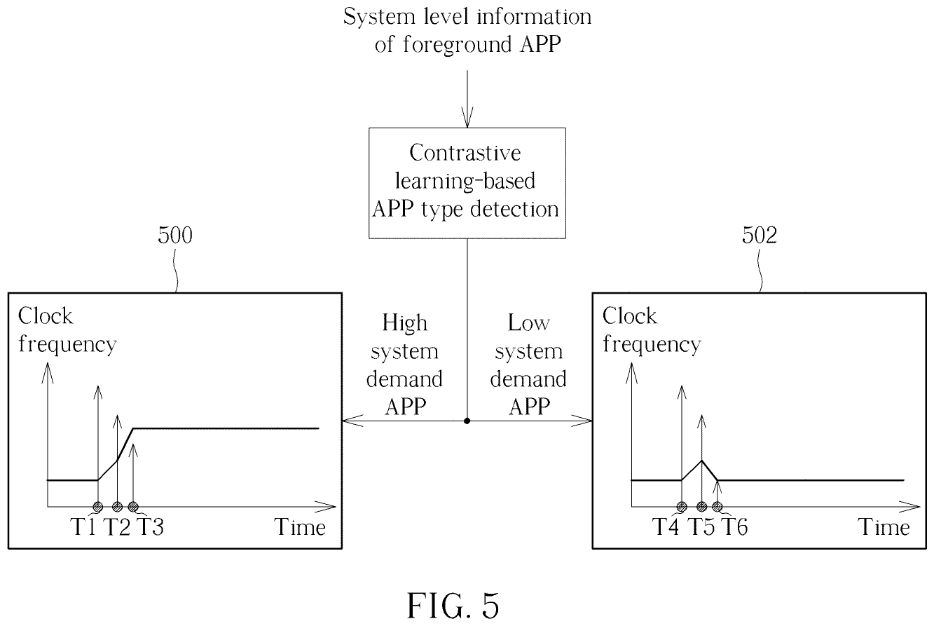

In Step S206, the system policy related to the processor 12 (e.g. the CPU or the GPU) may be adjusted/determined according to the detection result DET_R, wherein different APP types correspond to different system policies. More particularly, a clock frequency of the processor 12 may be increased or decreased according to the detection result DET_R. In detail, please refer to FIG. 5. FIG. 5 is a diagram illustrating some implementation details of adjusting a system policy with aid of APP type detection according to an embodiment of the present disclosure. As shown in FIG. 5, after foreground APP is classified into the high system demand APP or the low system demand APP according to detection result DET_R, the clock frequency of the processor 12 may be adjusted according to a classification result. In FIG. 5, there may be a diagram 500 corresponding to the high system demand APP and a diagram 502 corresponding to the low system demand APP, wherein each of the diagrams 500 and 502 has a horizontal axis showing the time and a vertical axis showing the clock frequency.

For the diagram 500, at a time T1, an APP (for example, a foreground APP) may start to run on the processor 12, and the clock frequency of the processor 12 may be correspondingly increased. At a time T2, the contrastive learning-based APP type detection operation (the above trained model) may be performed upon the APP according to the system level information of the APP in order to generate the detection result DET_R, and the APP is classified into a high system demand APP according to the detection result DET_R. At a time T3, in response to the APP being classified into the high system demand APP, the performance of the processor 12 may be boosted by further increasing the clock frequency of the processor 12.

For the diagram 502, at a time T4, an APP (for example, a foreground APP) may start to run on the processor 12, and the clock frequency of the processor 12 may be correspondingly increased. At a time T5, the contrastive learning-based APP type detection operation (the above trained model) may be performed upon the APP according to the system level information of the APP in order to generate the detection result DET_R, and the APP is classified into a low system demand APP according to the detection result DET_R. At a time T6, in response to the APP being classified into the low system demand APP, the clock frequency of the processor 12 may be decreased, to reduce power consumption.

In summary, by the method of the present disclosure, the model MOD trained by the contrastive learning method can be more robust to different versions of the same APP, and the accuracy of APP type detection can be improved. In addition, the operation or system policy can be adjusted according to the detection result DET_R, so that a balance between the power consumption and the performance of the electronic device 10 can be achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for application (APP) type detection, comprising:
collecting multiple system level information of multiple APPs, wherein the multiple APPs are related to at least two APP types; and
utilizing a contrastive learning method to train a machine learning model for obtaining a trained model, wherein the trained model is utilized for detecting an APP type of each of the multiple APPs, and the multiple system level information are utilized as multiple input data of the machine learning model.

2. The method of claim 1, wherein each of the multiple system level information comprises one of a system call, an application programming interface (API) call, and information related to a performance monitoring unit (PMU).

3. The method of claim 1, wherein the machine learning model is based on a temporal convolution network (TCN) architecture.

4. The method of claim 1, wherein the multiple APPs comprise at least one first APP belonging to a first APP type and at least one second APP belonging to a second APP type different from the first APP type, and each of positive pairs in a feature space comprises two features corresponding to a same APP type, wherein the two features are generated by the machine learning model respectively, and a similarity of the positive pairs in the feature space is maximized through the contrastive learning method.

5. The method of claim 4, wherein each of negative pairs in the feature space comprises a first feature corresponding to the first APP type and a second feature corresponding to the second APP type, the first feature and the second feature are generated by the machine learning model respectively, and a similarity of the negative pairs in the feature space is minimized through the contrastive learning method.

6. The method of claim 1, wherein the multiple APPs comprise at least one first APP belonging to a first APP type and at least one second APP belonging to a second APP type different from the first APP type, the multiple input data comprise multiple first input data corresponding to the first APP type and at least one second input data corresponding to the second APP type, and the step of utilizing the contrastive learning method to train the machine learning model comprises:
performing an augmentation operation upon a first input data corresponding to the first APP type, to generate an augmented result; and
training the machine learning model according to a loss function, wherein the loss function is related to multiple features, and the multiple features are generated by the machine learning model according to the multiple first input data, the augmented result and the at least one second input data, respectively.

7. The method of claim 6, wherein the step of performing the augmentation operation upon the first input data corresponding to the first APP type, to generate the augmented result comprises:
in response to the first input data being a system call sequence, randomly masking a section of the system call sequence to generate the augmented result; or
in response to the first input data being a system call count, randomly masking a discontinuous system call to generate the augmented result.

8. The method of claim 6, wherein the step of training the machine learning model according to the loss function comprises:
encoding the multiple first input data, respectively, to generate multiple first features through the machine learning model;
encoding the augmented result to generate a third feature through the machine learning model; and
encoding the at least one second input data, to generate at least one second feature through the machine learning model.

9. The method of claim 1, further comprising:
utilizing the trained model to perform a detection operation upon a foreground APP, to generate a detection result; and
determining a corresponding system policy according to the detection result, wherein different APP types correspond to different system policies.

10. The method of claim 1, further comprising:
after obtaining the trained model, training the trained model through a multilayer perceptron.

11. A non-transitory machine-readable medium for storing a program code, wherein when loaded and executed by a processor, the program code instructs the processor to perform a method for application (APP) type detection, and the method comprises:
collecting multiple system level information of multiple APPs, wherein the multiple APPs are related to at least two APP types; and
utilizing a contrastive learning method to train a machine learning model for obtaining a trained model, wherein the trained model is utilized for detecting an APP type of each of the multiple APPs, and the multiple system level information are utilized as multiple input data of the machine learning model.

12. The non-transitory machine-readable medium of claim 11, wherein each of the multiple system level information comprises one of a system call, an application programming interface (API) call, and information related to a performance monitoring unit (PMU).

13. The non-transitory machine-readable medium of claim 11, wherein the machine learning model is based on a temporal convolution network (TCN) architecture.

14. The non-transitory machine-readable medium of claim 11, wherein the multiple APPs comprise at least one first APP belonging to a first APP type and at least one second APP belonging to a second APP type different from the first APP type, and each of positive pairs in a feature space comprises two features corresponding to a same APP type, wherein the two features are generated by the machine learning model respectively, and a similarity of the positive pairs in the feature space is maximized through the contrastive learning method.

15. The non-transitory machine-readable medium of claim 14, wherein each of negative pairs in the feature space comprises a first feature corresponding to the first APP type and a second feature corresponding to the second APP type, the first feature and the second feature are generated by the machine learning model respectively, and a similarity of the negative pairs in the feature space is minimized through the contrastive learning method.

16. The non-transitory machine-readable medium of claim 11, wherein the multiple APPs comprise at least one first APP belonging to a first APP type and at least one second APP belonging to a second APP type different from the first APP type, the multiple input data comprise multiple first input data corresponding to the first APP type and at least one second input data corresponding to the second APP type, and the step of utilizing the contrastive learning method to train the machine learning model comprises:
performing an augmentation operation upon a first input data corresponding to the first APP type, to generate an augmented result; and
training the machine learning model according to a loss function, wherein the loss function is related to multiple features, and the multiple features are generated by the machine learning model according to the multiple first input data, the augmented result and the at least one second input data, respectively.

17. The non-transitory machine-readable medium of claim 16, wherein the step of performing the augmentation operation upon the first input data corresponding to the first APP type, to generate the augmented result comprises:
in response to the first input data being a system call sequence, randomly masking a section of the system call sequence to generate the augmented result; or
in response to the first input data being a system call count, randomly masking a discontinuous system call to generate the augmented result.

18. The non-transitory machine-readable medium of claim 16, wherein the step of training the machine learning model according to the loss function comprises:
encoding the multiple first input data, respectively, to generate multiple first features through the machine learning model;
encoding the augmented result to generate a third feature through the machine learning model; and
encoding the at least one second input data, to generate at least one second feature through the machine learning model.

19. The non-transitory machine-readable medium of claim 11, wherein the method further comprises:
utilizing the trained model to perform a detection operation upon a foreground APP, to generate a detection result; and
determining a corresponding system policy according to the detection result, wherein different APP types correspond to different system policies.

20. The non-transitory machine-readable medium of claim 11, wherein the method further comprises:
after obtaining the trained model, training the trained model through a multilayer perceptron.
